(19) United States
(12) Patent Application Publication
(10) Pub. No.: US 2017/0344266 A1
(43) Pub. Date: Nov. 30, 2017

(54) METHODS FOR DYNAMIC RESOURCE RESERVATION BASED ON CLASSIFIED I/O REQUESTS AND DEVICES THEREOF

(71) Applicant: NetApp, Inc., Sunnyvale, CA (US)

(72) Inventors: Abdul Basit, Morrisville, NC (US); John Scott, Cary, NC (US); Ashwin Palani, Cary, NC (US); Dean Kalman, Cary, NC (US)

(21) Appl. No.: 15/166,876

(22) Filed: May 27, 2016

(51) Int. Cl. G06F 3/06

(52) U.S. Cl. CPC G06F 3/0605; G06F 3/067; G06F 3/0613; G06F 3/0637; G06F 3/0659

(57) ABSTRACT

A method, non-transitory computer readable medium, and device that assists with dynamic resource reservation based on classified input/output requests includes receiving an input/output request from a client computing device. The input/output request is classified as a first priority request, wherein the first priority request has priority to a second priority request. A deadline time period to execute the received input/output request classified as the first priority request is determined and the first priority request is added to a first priority queue. The first priority request in the first priority queue is processed by assigning a plurality of reserved resources.

### FIELD

This technology generally relates to data storage management and, more particularly, methods for dynamic resource reservation based on classified input/output requests and devices thereof.

### BACKGROUND

Large scale shared storage systems typically provide data to multiple applications or workload classes with differing performance requirements. Existing Quality of Service (QoS) approaches for controlling resource allocation in such storage systems was performed by I/O scheduling based on fair scheduling algorithms. A limitation of existing resource allocation techniques is that they focus mainly on fairness but do not account for the trade-off between fairness and I/O efficiency.

When multiple input/output requests with different performance requirements, priorities, and workload characteristics share storage, it can be difficult to ensure that each receives a particular performance requirement. Additionally, higher priority input/output requests can experience lesser performance degradation if shared storage resources are limiting

### BRIEF DESCRIPTION OF THE DRAWINGS

FIG. 1 is a block diagram of an environment with a storage management computing device that provides dynamic resource reservation based on classified input/output requests;

FIG. 2 is a block diagram of the exemplary storage management computing device shown in FIG. 1; and

FIG. 3 is an exemplary flow chart of an example of a method for dynamic resource reservation based on classified input/output requests.

### DETAILED DESCRIPTION

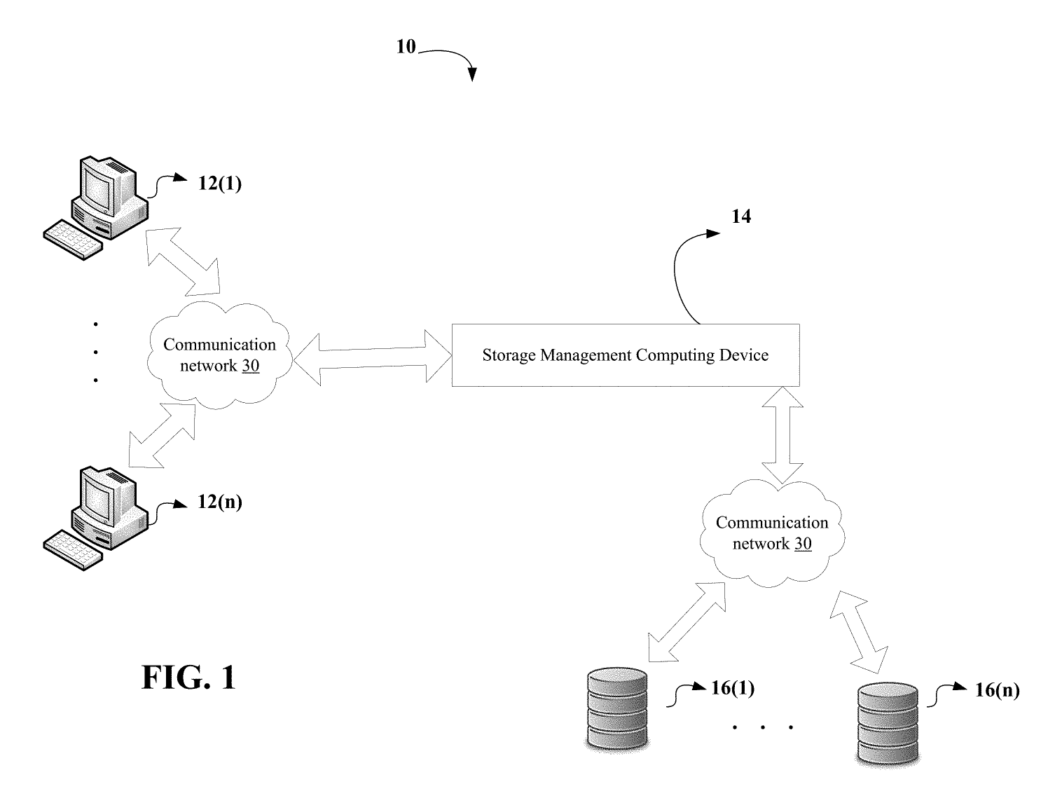

An environment 10 with a plurality of client computing devices 12(1)-12(n), an exemplary storage management computing device 14, a plurality of storage drives 16(1)-16(n) is illustrated in FIG. 1. In this particular example, the environment 10 in FIG. 1 includes the plurality of client computing devices 12(1)-12(n), the storage management computing device 14 and a plurality of storage drives 16(1)-16(n) coupled via one or more communication networks 30, although the environment could include other types and numbers of systems, devices, components, and/or other elements. The example of a method for dynamic resource reservation based on classified input/output requests is executed by the storage management computing device 14, although the approaches illustrated and described herein could be executed by other types and/or numbers of other computing systems and devices. The environment 10 may include other types and numbers of other network elements and devices, as is generally known in the art and will not be illustrated or described herein. This technology provides a number of advantages including providing methods, non-transitory computer readable media and devices for dynamic resource reservation based on classified input/output requests.

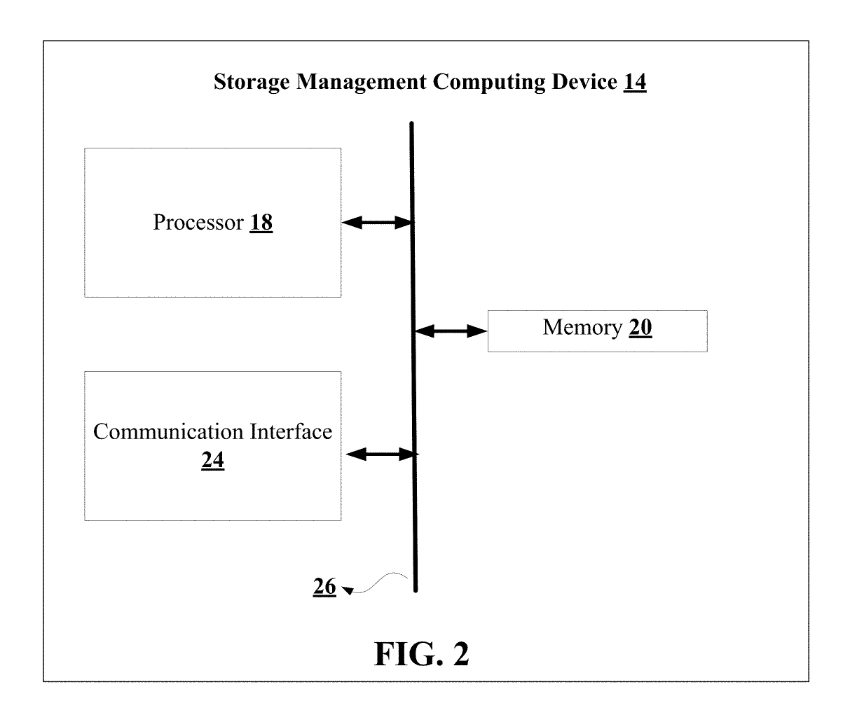

Referring to FIG. 2, in this example the storage management computing device 14 includes a processor 18, a memory 20, and a communication interface 24 which are coupled together by a bus 26, although the storage management computing device 14 may include other types and numbers of elements in other configurations.

The processor 18 of the storage management computing device 14 may execute one or more programmed instructions stored in the memory 20 for dynamic resource reservation based on classified input/output requests as illustrated and described in the examples herein, although other types and numbers of functions and/or other operation can be performed. The processor 18 of the storage management computing device 14 may include one or more central processing units (“CPUs”) or general purpose processors with one or more processing cores, such as AMD® processor(s), although other types of processor(s) could be used (e.g., Intel®).

The memory 20 of the storage management computing device 14 stores the programmed instructions and other data for one or more aspects of the present technology as described and illustrated herein, although some or all of the programmed instructions could be stored and executed elsewhere. A variety of different types of memory storage devices, such as a non-volatile memory, random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 18, can be used for the memory 20.

The communication interface 24 of the storage management computing device 14 operatively couples and communicates with the plurality of client computing devices 12(1)-12(n) and the plurality of storage drives 16(1)-16(n), which are all coupled together by the communication network 30, although other types and numbers of communication networks or systems with other types and numbers of connections and configurations to other devices and elements. By way of example only, the communication network 30 can use TCP/IP over Ethernet and industry-standard protocols, including NFS, CIFS, SOAP, XML, LDAP, and SNMP, although other types and numbers of communication networks, can be used. The communication networks 30 in this example may employ any suitable interface mechanisms and network communication technologies, including, for example, any local area network, any wide area network (e.g., Internet), teletraffic in any suitable form (e.g., voice, modem, and the like), Public Switched Telephone Network (PSTNs), Ethernet-based Packet Data Networks (PDNs), and any combinations thereof and the like. In this example, the bus 26 is a universal serial bus, although other bus types and links may be used, such as PCI-Express or hyper-transport bus.

Each of the plurality of client computing devices 12(1)-12(n) includes a central processing unit (CPU) or processor, a memory, and an I/O system, which are coupled together by a bus or other link, although other numbers and types of network devices could be used. The plurality of client computing devices 12(1)-12(n) communicates with the storage management computing device 14 for storage management, although the client computing devices 12(1)-12(n) can interact with the storage management computing device 14 for other purposes. By way of example, the plurality of client computing devices 12(1)-12(n) may run application(s) that may provide an interface to make requests to access, modify, delete, edit, read or write data within storage management computing device 14 or the plurality of storage drives 16(1)-16(n) via the communication network 30.

Each of the plurality of storage drives 16(1)-16(n) includes a central processing unit (CPU) or processor, and an I/O system, which are coupled together by a bus or other link, although other numbers and types of network devices could be used. Each plurality of storage drives 16(1)-16(n) assists with storing data, although the plurality of storage drives 16(1)-16(n) can assist with other types of operations such as storing of files or data. Various network processing applications, such as CIFS applications, NFS applications, HTTP Web Data storage device applications, and/or FTP applications, may be operating on the plurality of storage drives 16(1)-16(n) and transmitting data (e.g., files or web pages) in response to requests from the storage management computing device 14 and the plurality of client computing devices 12(1)-12(n). It is to be understood that the plurality of storage drives 16(1)-16(n) may be hardware or software or may represent a system with multiple external resource servers, which may include internal or external networks.

Although the exemplary network environment 10 includes the plurality of client computing devices 12(1)-12(n), the storage management computing device 14, and the plurality of storage drives 16(1)-16(n) described and illustrated herein, other types and numbers of systems, devices, components, and/or other elements in other topologies can be used. It is to be understood that the systems of the examples described herein are for exemplary purposes, as many variations of the specific hardware and software used to implement the examples are possible, as will be appreciated by those of ordinary skill in the art.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic media, wireless traffic networks, cellular traffic networks, G3 traffic networks, Public Switched Telephone Network (PSTNs), Packet Data Networks (PDNs), the Internet, intranets, and combinations thereof.

The examples also may be embodied as a non-transitory computer readable medium having instructions stored thereon for one or more aspects of the present technology as described and illustrated by way of the examples herein, as described herein, which when executed by the processor, cause the processor to carry out the steps necessary to implement the methods of this technology as described and illustrated with the examples herein.

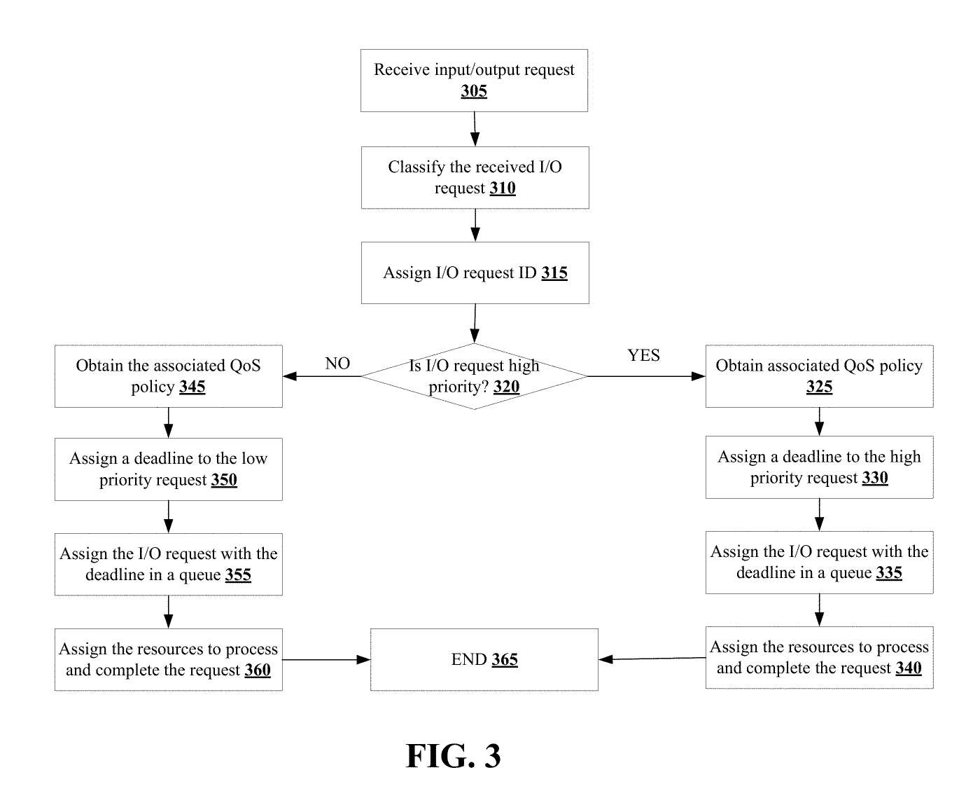

An example of a method for dynamic resource reservation based on classified input/output requests will now be described herein with reference to FIGS. 1-3. The exemplary method begins at step 305 where the storage management computing device 14 receives an input/output (I/O) request from one of the plurality of client computing devices 12(1)-12(n), although the storage management computing device 14 can receive other types or amounts of requests from other devices. In this example, the received I/O request includes requesting access to an object stored in the plurality of storage drives 16(1)-16(n), although the storage management computing device 14 can receive other types of I/O requests from other devices.

Next in step 310, the storage management computing device 14 classifies the received I/O request. In this example, the storage management computing device 14 classifies the I/O request based on the type of the object being requested, although the storage management computing device 14 can classify the I/O request based on other types of parameters such as type of the requesting one of the plurality of client computing devices 12(1)-12(n) or the virtual machine using which the requested object is being accessed. By way of example only, the storage management computing device 14 classifies the received I/O request as either a high priority I/O request or a low priority I/O request based on the type of obj ect being accessed. Additionally in this example, the storage management computing device 14 can in parallel start reserving the computing resources that is required to process the received I/O request classified as high priority I/O request. Furthermore in this example, the storage management computing device 14 can determine the number of resources to be reserved based on analysis of historical data of similar types of received I/O requests, although the storage management computing device 14 can use other parameters to determine the number of resources to be reserved.

Next in step 315, the storage management computing device 14 assigns a unique I/O request identifier to the classified I/O request. In this example, the storage management computing device 14 assigns the unique I/O request identifier to identify whether the received I/O request is a high priority or a low priority I/O request using minimum number of processing cycles.

Next in step 320, the storage management computing device 14 determines whether the received I/O request is high priority based on the assigned unique I/O request identifier. By determining whether the received I/O request is a high priority request, the technology disclosed in able to dynamically assign the resources that were reserved anticipating the high priority I/O request. Accordingly, when the storage management computing device 14 determines that the received I/O request is a high priority request, then the Yes branch is taken to step 325.

In step 325, the storage management computing device 14 identifies and obtains quality of service (QoS) policy associated with the classified high priority I/O request. In this example, the storage management computing device 14 identifies and obtains the QoS policy from memory 20 based on the assigned unique I/O request identifier or the type of the object being requested, although the storage management computing device 14 can identify and obtain the QoS policy from other memory locations based on different parameters. Alternatively, the storage management computing device 14 can obtain the QoS policy based on the type of the requesting one of the plurality of client computing devices 12(1)-12(n). In this example, QoS policy includes data associated with the number of resources required to process the high priority I/O request and the expected throughput, although the QoS policy can include other types and amounts of information.

In step 330, the storage management computing device 14 assigns a deadline time period to the high priority I/O request within which the high priority I/O request has to be processed and completed. In this example, the storage management computing device 14 assigns the deadline time period based on the data in the QoS policy, object being accessed, and/or unique I/O request identifier assigned, although the deadline can be assigned based on other types or amounts of parameters.

Next in step 335, the storage management computing device 14 assigns the received high priority I/O request into a high priority work queue. In this example, the high priority work queue includes all the high priority I/O request that are sorted based on the deadline time period associated with each of the high priority I/O request, although the high priority I/O requests in the high priority work queue can be sorted based on other types or numbers of parameters. Further in this example, the storage management computing device 14 determines to release the high priority I/O request from the high priority work queue for further processing and execution based on the deadline time period associated with the high priority I/O request, although the storage management computing device 14 can use other parameters to decide the time and order at which the high priority I/O request can be released from the high priority work queue for further processing and execution.

In step 340, the storage management computing device 14 assigns the resources that were reserved for the anticipated the high priority I/O request to the high priority I/O request having the shortest deadline time period in the high priority work queue. By way of example, the resources include the processor, buffer memory, or disk storage, although the resources can include other types or amounts of information. In this example, the storage management computing device 14 assigns the resources based on the data present in the QoS policy associated with the high priority I/O request. The resources are assigned by the storage management computing device 14 to match the expected throughput disclosed in the QoS policy. Optionally, the storage management computing device 14 can determine when there is a requirement for additional resources that are required to be assigned to the high priority request in addition to the dynamically reserved. The storage management computing device 14 can then assign the determined additional resources in addition to the anticipated resources to the high priority request for further processing and the exemplary method ends at step 365.

However back in step 320, when the storage management computing device 14 determines that the received I/O request is not a high priority I/O request, then the No branch is taken to step 345.

In step 345, the storage management computing device 14 identifies and obtains quality of service (QoS) policy associated with the classified low priority I/O request. In this example, the storage management computing device 14 identifies and obtains the QoS policy from memory 20 based on the assigned unique I/O request identifier or the type of the object being requested, although the storage management computing device 14 can identify and obtain the QoS policy from other memory locations based on different parameters. Alternatively, the storage management computing device 14 can obtain the QoS policy based on the type of the requesting one of the plurality of client computing devices 12(1)-12(n). In this example, QoS policy includes data associated with the number of resources required to process the low priority I/O request and the expected throughput, although the QoS policy can include other types and amounts of information.

In step 350, the storage management computing device 14 assigns a deadline time period to the low priority I/O request within which the low priority I/O request has to be processed and completed. In this example, the storage management computing device 14 assigns the deadline time period based on the data in the QoS policy, object being accessed, and/or unique I/O request identifier assigned, although the deadline can be assigned based on other types or amounts of parameters.

Next in step 355, the storage management computing device 14 assigns the received low priority I/O request into a low priority work queue. In this example, the low priority work queue includes all the low priority I/O request that are sorted based on the deadline time period associated with each of the low priority I/O request, although the low priority I/O requests in the low priority work queue can be sorted based on other types or numbers of parameters. Further in this example, the storage management computing device 14 determines to release the low priority I/O request from the low priority work queue for further processing and execution based on the deadline time period associated with the low priority I/O request, although the storage management computing device 14 can use other parameters to decide the time and order at which the low priority I/O request can be released from the low priority work queue for further processing and execution.

In step 360, the storage management computing device 14 assigns the resources that are remaining either during the parallel execution of the high priority I/O requests illustrated in steps 325-340 or the resources relinquished after the completion of all the high priority I/O requests from the high priority work queue to the low priority I/O request having the shortest deadline time period in the low priority work queue. By way of example, the resources include the processor, buffer memory, or disk storage, although the resources can include other types or amounts of information. In this example, the storage management computing device 14 assigns the resources based on the data present in the QoS policy associated with the high priority I/O request. The resources are assigned by the storage management computing device 14 to match the expected throughput disclosed in the QoS policy. The exemplary method ends at step 360.

Optionally in another example, the storage management computing device 14 can wait until the execution of all the high priority I/O requests from the high priority work queue and then process the low priority I/O requests with or without performing steps illustrated from 345-360. Alternatively in another example, the storage management computing device 14 can perform one or more of the illustrated steps 345-360 to process the low priority I/O requests.

Accordingly, as illustrated and described by way of the examples herein, this technology provides a number of advantages including providing methods, non-transitory computer readable media and devices for dynamic resource reservation based on classified input/output requests. Using the technique illustrated above, the technology disclosed is able to maximize the total I/O throughput by effectively classifying the received I/O requests into low and high priority I/O requests. Additionally, the technology is able to anticipate and dynamically reserve the resources for the high priority I/O requests thereby processing the I/O requests without starving for resources.

Having thus described the basic concept of the technology, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the technology. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for dynamic resource reservation based on classified input/output requests, the method comprising:
receiving, by a storage management computing device, an input/output request from a client computing device;
classifying, by the storage management computing device, the received input/output request as a first priority request, wherein the first priority request has priority to a second priority request;
determining, by the storage management computing device, a deadline time period to execute the received input/output request classified as the first priority request and adding the first priority request into a first priority queue; and
processing, by the storage management computing device, the first priority request in the high priority queue by assigning a plurality of reserved resources.

2. The method as set forth in claim 1 wherein the classifying further comprises, dynamically reserving, by the storage management computing device, the plurality of reserved resources prior to the determining or the processing.

3. The method as set forth in claim 2 further comprises determining, by the storage management computing device, a number resources to be dynamically reserved for each of the plurality of the reserved resources based on historical data or a pattern analysis.

4. The method as set forth in claim 1 further comprising obtaining, by the storage management computing device, a quality of service policy associated with the first priority request, wherein the quality of service policy comprises at least an expected throughput data.

5. The method as set forth in claim 4 further comprising assigning, by the storage management computing device, the plurality of reserved resources for the first priority request based on the quality of service policy.

6. The method as set forth 1 wherein the high priority request is processed from the first priority queue based on the determined time period.

7. A non-transitory computer readable medium having stored thereon instructions for dynamic resource reservation based on classified input/output requests comprising executable code which when executed by a processor, causes the processor to perform steps comprising:
receiving an input/output request from a client computing device;
classifying the received input/output request as a a first priority request, wherein the first priority request has priority to a second priority request;
determining a deadline time period to execute the received input/output request classified as the first priority request and adding the first priority request into a first priority queue; and
processing the first priority request in the first priority queue by assigning a plurality of reserved resources.

8. The medium as set forth in claim 7 wherein the classifying further comprises, dynamically reserving the plurality of reserved resources prior to the determining or the processing.

9. The medium as set forth in claim 8 further comprises determining a number resources to be dynamically reserved for each of the plurality of the reserved resources based on historical data or a pattern analysis.

10. The medium as set forth in claim 7 further comprising obtaining a quality of service policy associated with the first priority request, wherein the quality of service policy comprises at least an expected throughput data.

11. The medium as set forth in claim 10 further comprising assigning the plurality of reserved resources for the first priority request based on the quality of service policy.

12. The medium as set forth in claim 7 wherein the high priority request is processed from the first priority queue based on the determined time period.

13. A storage management computing device comprising:
a processor;
a memory coupled to the processor which is configured to be capable of executing programmed instructions comprising and stored in the memory to:
receive an input/output request from a client computing device;
classify the received input/output request as a first priority request, wherein the first priority request has priority to a second priority request;
determine a deadline time period to execute the received input/output request classified as the high priority request and adding the first priority request into a first priority queue; and
process the first priority request in the first priority queue by assigning a plurality of reserved resources.

14. The device as set forth in claim 13 wherein the processor coupled to the memory is further configured to be capable of executing at least one additional programmed instruction comprising and stored in the memory to the classifying further comprises dynamically reserve the plurality of reserved resources prior to the determining or the processing.

15. The device as set forth in claim 14 wherein the processor coupled to the memory is further configured to be capable of executing at least one additional programmed instruction comprising and stored in the memory to determine a number resources to be dynamically reserved for each of the plurality of the reserved resources based on historical data or a pattern analysis.

16. The device as set forth in claim 13 wherein the processor coupled to the memory is further configured to be capable of executing at least one additional programmed instruction comprising and stored in the memory to obtain a quality of service policy associated with the first priority request, wherein the quality of service policy comprises at least an expected throughput data.

17. The device as set forth in claim 16 wherein the processor coupled to the memory is further configured to be capable of executing at least one additional programmed instruction comprising and stored in the memory to assign the plurality of reserved resources for the first priority request based on the quality of service policy.

18. The device as set forth in claim 10 wherein the high priority request is processed from the first priority queue based on the determined time period.
